(19) United States
(12) Patent Application Publication
(10) Pub. No.: US 2009/0207142 A1
(43) Pub. Date: Aug. 20, 2009

(54) Apparatus, method, computer program and user interface for enabling user input

(75) Inventor: Pasi Kaleva Keranen, Oulu (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/070,812

(22) Filed: Feb. 20, 2008

(51) Int. Cl. G06F 3/041

(52) U.S. Cl. 345/173

(57) ABSTRACT

An apparatus including a display configured to present an object; a touch sensitive input device configured to enable a user to make touch inputs, including trace inputs; and a processor configured to perform a geometric transformation of the object on the display in response to a sequence of distinct touch inputs of the touch sensitive input device, the sequence including a first touch input and a second touch input wherein the first touch input in the sequence defines an invariant point in the object and the second touch input in the sequence defines the geometric transformation.

### FIELD OF THE INVENTION

Embodiments of the present invention relate to an apparatus, method, computer program and user interface for enabling user input. In particular, they relate to an apparatus, method, computer program and user interface for enabling user input using a touch sensitive input device such as a touch sensitive display.

### BACKGROUND TO THE INVENTION

Apparatus having touch sensitive input devices such as touch pads or touch sensitive displays which enable a user to make inputs via the display are well known. A user may wish to use such touch sensitive input devices to perform geometric transformations of objects such as images which are presented on a display. Such geometric transformations may include re-scaling and/or rotation of the objects.

### BRIEF DESCRIPTION OF THE INVENTION

According to one embodiment of the invention there is provided an apparatus comprising: a display configured to present an object; a touch sensitive input device configured to enable a user to make touch inputs, including trace inputs; and a processor configured to perform a geometric transformation of the object on the display in response to a sequence of distinct touch inputs of the touch sensitive input device, the sequence including a first touch input and a second touch input wherein the first touch input in the sequence defines an invariant point in the object and the second touch input in the sequence defines the geometric transformation.

This provides the advantage that a user can perform geometric transformation of an object using only one hand to operate the device because the inputs required to make the transformation are made sequentially. This is particularly advantageous for hand held electronic devices such as personal digital assistants and mobile cellular telephones.

Also the use of a second input to define the geometric transformation performed is intuitive to a user and therefore makes the device easier to use.

Also as the inputs are made sequentially the processor and the touch sensitive input device only need to be configured to detect and process a single input at any one time. This allows for a simple touch sensitive user input device to be used and reduces the processing capacity required.

Embodiments of the invention also provide the advantage that, as an invariant point is defined, more complicated geometric transformations can be performed, for example rotations or simultaneous rotations and resealing.

According to another embodiment of the invention there is provided a method comprising: presenting an object on a display; detecting a sequence of distinct touch inputs on a touch sensitive user input device, the sequence including a first touch input and a second touch input; defining, in response to the detection of the first touch input, an invariant point of the object; and performing, in response to the detection of the second touch input, geometric transformation of the object about the invariant point wherein the second touch input defines the geometric transformation.

According to another embodiment of the invention there is provided a computer program comprising program instructions for controlling an apparatus, the apparatus comprising, a display configured to present an object and a touch sensitive input device configured to enable a user to make touch inputs, including trace inputs, the program instructions providing, when loaded into a processor: means for detecting a sequence of distinct touch inputs on a touch sensitive user input device, the sequence including a first touch input and a second touch input; means for defining, in response to the detection of the first touch input an invariant point of the object; and means for performing, in response to the detection of the second touch input, geometric transformation of the object about the invariant point wherein the second touch input defines the geometric transformation.

According to another embodiment of the invention there is provided a user interface comprising: a display for presenting an object in a first geometric configuration; a touch sensitive input device configured to enable a user to make touch inputs, including trace inputs; wherein the user interface is configured such that a geometric transformation of the object on the display is performed in response to a sequence of distinct touch inputs wherein a first touch input in the sequence defines an invariant point in the object and a second touch input in the sequence determines the geometric transformation about the invariant point.

According to another embodiment of the invention there is provided an apparatus comprising: a display configured to present an object; a touch sensitive input device configured to enable a user to make touch inputs, including trace inputs; and a processor configured to perform a function the object on the display in response to a sequence of distinct touch inputs of the touch sensitive input device, the sequence including a first touch input and a second touch input wherein the first touch input in the sequence defines an invariant point in the object and the second touch input in the sequence defines the function.

The apparatus may be for wireless communication.

### BRIEF DESCRIPTION OF THE DRAWINGS

For a better understanding of the present invention reference will now be made by way of example only to the accompanying drawings in which:

FIG. 1 schematically illustrates an electronic apparatus;

FIG. 2 illustrates a flow chart showing method blocks of an embodiment of the present invention;

FIGS. 3A to 3E illustrate a graphical user interface according to an embodiment the present invention.

### DETAILED DESCRIPTION OF EMBODIMENTS OF THE INVENTION

The Figures illustrate an apparatus 1 comprising: a display 11 configured to present an object 43; a touch sensitive input device 13 configured to enable a user to make touch inputs, including trace inputs; and a processor 3 configured to perform 29 a geometric transformation of the object 43 on the display 11 in response to a sequence of distinct touch inputs of the touch sensitive input device, the sequence including a first touch input and a second touch input wherein the first touch input in the sequence defines an invariant point 63 in the object 43 and the second touch input in the sequence defines the geometric transformation.

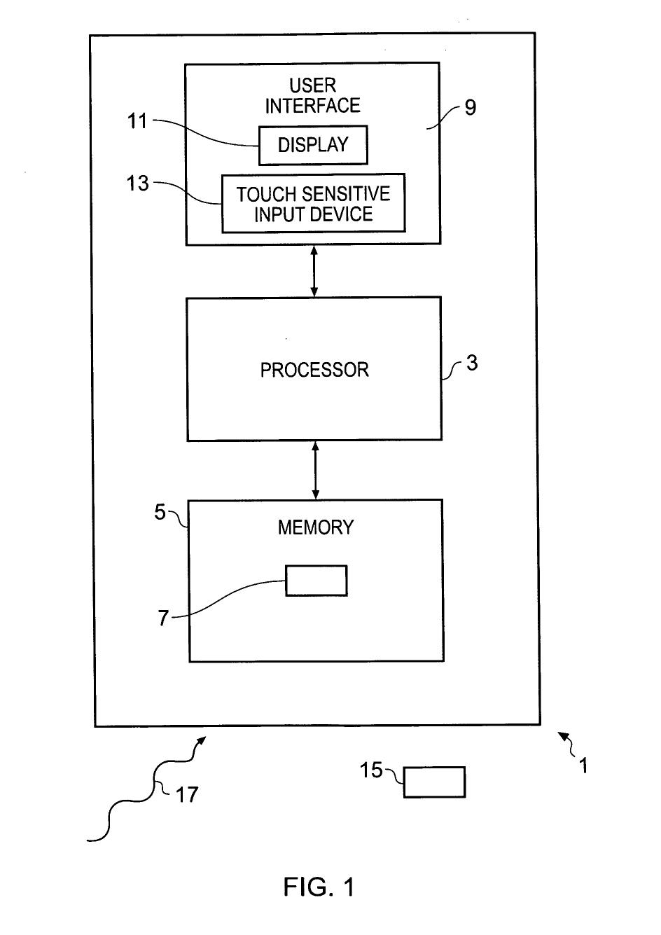

FIG. 1 schematically illustrates an electronic apparatus 1. Only the features referred to in the following description are illustrated. It should, however, be understood that the apparatus 1 may comprise additional features that are not illustrated. The electronic apparatus 1 may be, for example, a personal computer, a personal digital assistant, a mobile cellular telephone, or any other electronic apparatus that comprises a touch sensitive input device 13 which enables a user to make touch inputs. The electronic apparatus 1 may be a handheld apparatus 1 which can be carried in a user's hand, handbag or jacket pocket for example.

The illustrated electronic apparatus 1 comprises: a user interface 9, a memory 5 and a processor 3. The processor 3 is connected to receive input commands from the user interface 9 and to provide output commands to the user interface 9. The processor 3 is also connected to write to and read from the memory 5.

The user interface 9 comprises a display 11 and a touch sensitive user input device 13. The touch sensitive user input device 13 may be, for example a touch sensitive display configured to enable a user to make inputs via the display 11. Alternatively the touch sensitive user input device 13 may be a touch pad or any other user input device which is configured to detect a touch input of a user and associate this with a displayed object.

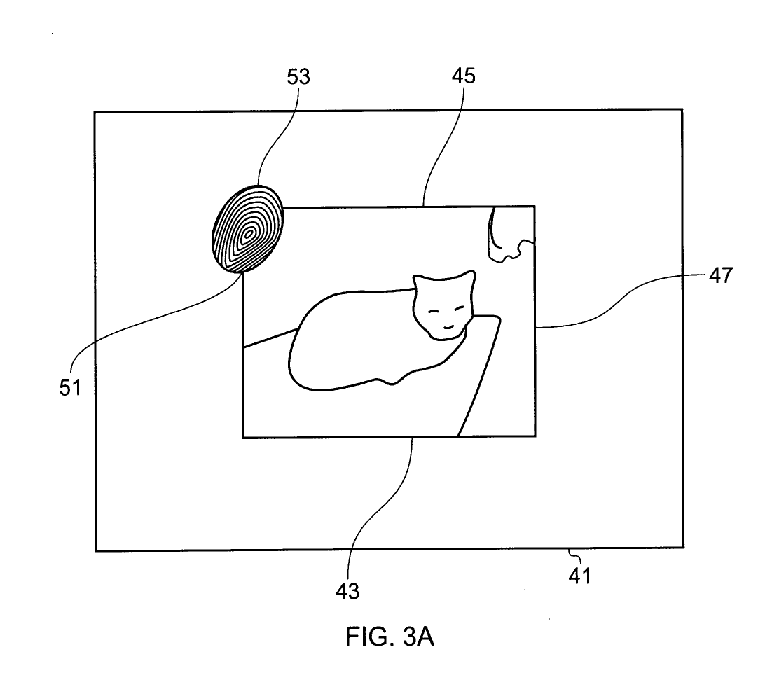

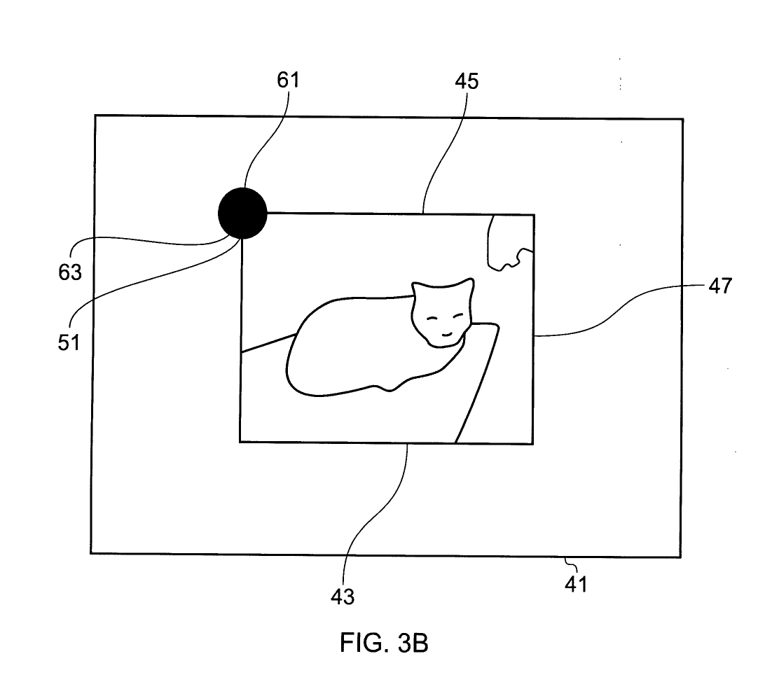

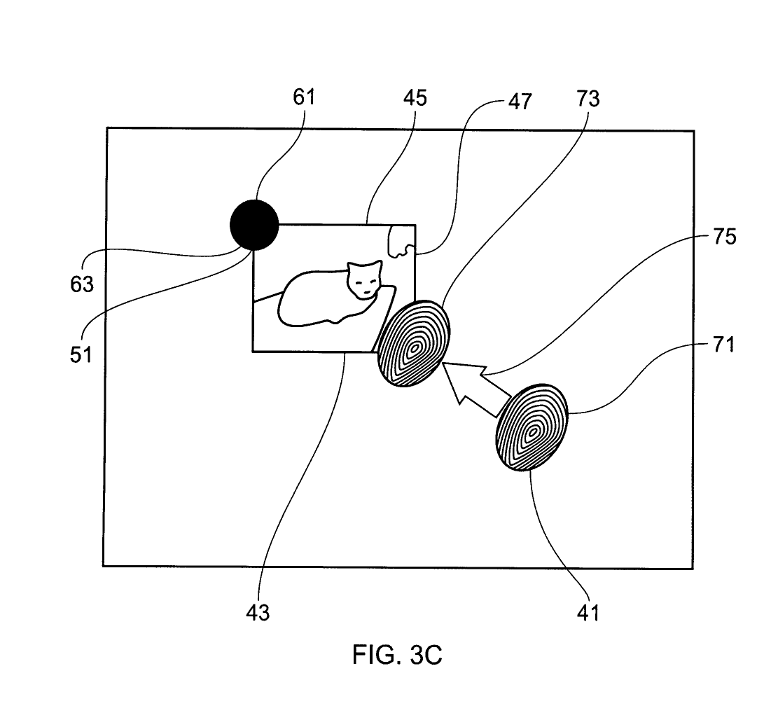

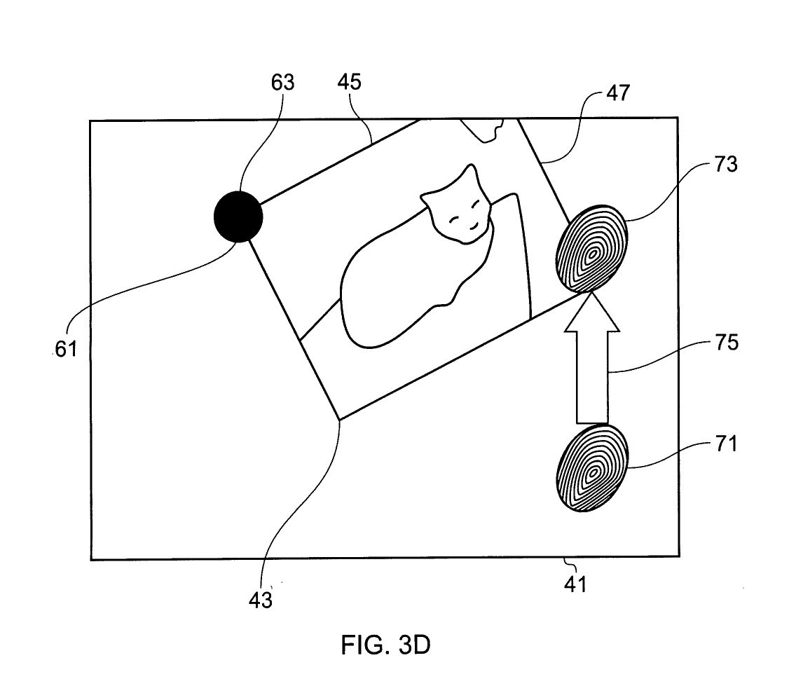

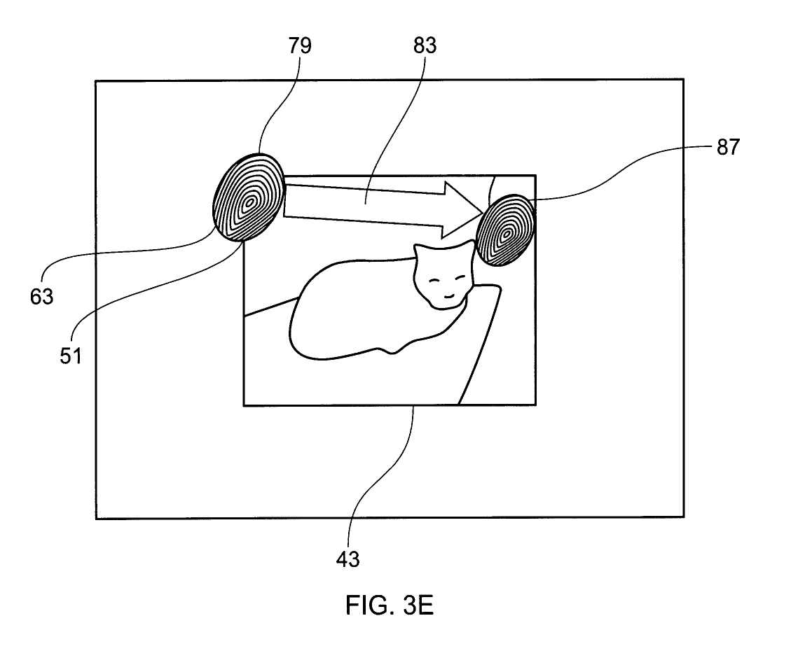

The display 11 is configured to present a graphical user interface to a user. Examples of graphical user interfaces according to an embodiment of the invention are illustrated in FIGS. 3A to 3E.

The display 11 is also configured to present one or more objects 43 to a user. An object may be an image, a window, a piece of text or any other entity on which a geometric transformation such as re-scaling or rotation may be performed.

The touch sensitive input device 13 is configured to enable a user to make a sequence of touch inputs which are detected by the processor. Each input in the sequence may be started only after the preceding input has been completed. In order to enable the processor 3 to detect a touch input the touch sensitive input device 13 may require contact between a finger or stylus and the surface of the touch sensitive input device 13. Alternatively the touch sensitive input device 13 may merely require the finger or stylus to be brought close to the surface of the touch sensitive input device 13.

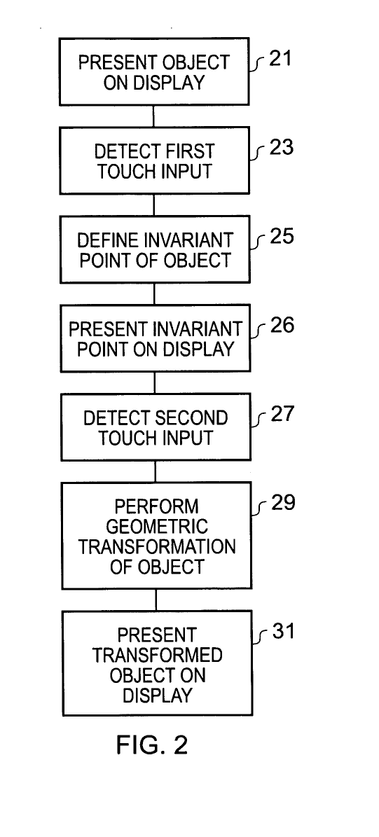

The memory 5 stores computer program instructions 7, which when loaded into the processor 3, enable the processor 3 to control the operation of the device 1 as described below. The computer program instructions 7 provide the logic and routines that enables the electronic apparatus 1 to perform the method illustrated in FIG. 2.

The computer program instructions 7 may arrive at the electronic apparatus 1 via an electromagnetic carrier signal 17 or be copied from a physical entity such as a computer program product 15, a memory device or a record medium such as a CD-ROM or DVD, where it has been tangibly encoded.

A method of controlling the apparatus 1, according to the present invention, is illustrated schematically in FIG. 2.

At block 21 an object 43 is presented on the display 11. The object 43 may be any entity upon which a geometric transformation such as rescaling or rotation may be performed. For example the object 43 may be an image, a window or a piece of text. There may be more than one object 43 presented on the display 11 at once.

The object 43 presented on the display 11 has a particular geometric configuration. For example, it may be presented in a particular orientation on the display 11 and having a particular size and shape.

At block 23 the processor 3 detects a first touch input in a sequence of distinct touch inputs on the touch sensitive user input device 13. The first touch input may be a particular type of input such as a long tap input or an extra long tap input in which the user actuates an area of the touch sensitive user input device 13 for at least a predetermined time period. Alternatively, in embodiments where the touch sensitive input device 13 is configured to detect the force of the touch input, the first touch input may be a press of the touch sensitive input device 13 which exceeds a predetermined force. Alternatively the first touch input may be made using a particular stylus or finger or actuating a particular region of the touch sensitive input device 13.

In embodiments where the touch sensitive input device 13 is a touch sensitive display the first touch input may be made by actuating any region of the display 11 in which the object 43 is presented.

In response to the detection of the first user input the processor 3 defines, at block 25, an invariant point 63 in the object 43 and, at block 26, presents an indication of the position of the invariant point on the display 11. The invariant point 63 is a point of the object 43 which remains fixed when a geometric transformation is performed on the object 43. For example it may define an origin about which a rotation of the object 43 is performed or it may be a point which remains fixed on the display while the object 43 is rescaled.

The invariant point 63 may be a user determined point. For example it may be the point of the object 43 at which the first touch input was made. Alternatively the invariant point may be predetermined, for example it may be the central point of the object 43.

At block 27 the processor 3 detects a second touch input in the sequence of inputs on the touch sensitive user input device 13. The second touch input may be a separate and distinct input from the first touch input. For example the user may break the contact with the touch sensitive input device 13 between the first touch input and the second touch input, or a predetermined amount of time may expire between the completion of the first touch input and the start of the second touch input.

The second touch input may be a predetermined type of input similar to the first user input. The second touch input may also be a trace input in which the user drags their finger or a stylus across the surface of the touch sensitive input device 13. In embodiments where the touch sensitive input device 13 is a touch sensitive display the trace input may start on a region of the display 11 in which the object 43 is presented.

In response to the detection of the second touch input the processor 3 will perform a function such as a geometric transformation of the object 43. For example, the processor 3 may rescale and or rotate the object 43 presented on the display 11.

The geometric transformation performed is determined by the second touch input. The second touch input may be measured relative to the position of the invariant point 63. For example, where the second touch input is a trace input, the direction of the trace relative to the invariant point 63 may define the type of geometric transformation performed and the length of the trace may define the magnitude of the geometric transformation. For example, the direction of the trace may determine whether the geometric transformation is an increase in scale, a decrease in scale, a rotation or a combination of rotation and resealing. The length of the trace may determine the amount by which the object 43 is rotated, increased or decreased.

Once the geometric transformation of the object 43 has been completed the object 43 is presented, at block 31, on the display 11 in the geometric configuration which results from the geometric transformation of the original geometric transformation.

In some embodiments once the geometric transformation has been completed the invariant point will be cancelled and the indication of the invariant point on the display will be removed.

Alternatively, in other embodiments the invariant point will remain defined after the geometric transformation has been completed. This enables a user to make a further touch input defining a further geometric transformation with respect to the same invariant point. This may be advantageous if the user wishes to make several geometric transformations of the same object. In such embodiments the touch sensitive input device 13 may also be configured to detect an input and in response to the input cancel the invariant point. Such an input may be a particular type of input such as a long tap or actuating of the touch sensitive input device 13 with a predetermined force etc.

FIGS. 3A to 3E illustrate a graphical user interface 41 which is presented on the display 11 according to an embodiment of the invention in use. In this particular embodiment the touch sensitive input device 13 is a touch sensitive display. It is to be appreciated that other types of input devices and displays may be used.

In FIG. 3A an object 43 is presented on the display 11. In this particular example the object 43 is an image. The object 43 is rectangular and has a first side 45 and a second side 47 where the first side 45 is longer than and perpendicular to the second side 47. In the graphical user interface 41 illustrated in FIG. 3A the object 43 is displayed in landscape orientation so that the first side 45 is horizontal.

In FIG. 3A the user makes a first touch input, which in this embodiment is a tap input, by using their finger 53 to actuate the region of the display 11 in which the top left hand corner 51 of the object 43 is presented for at least a predetermined amount of time.

FIG. 3B illustrates the graphical user interface 41 which is presented once the processor 3 has detected 23 the first touch input and defined 25 the invariant point 63. An icon 61 is presented to indicate the location of the invariant point 63. In the embodiment illustrated in FIG. 3B the invariant point 63 is the point at which the first touch input was made, that is, the top left hand corner 51 of the object 43. In other embodiments the invariant point 63 may be in a predetermined position which is independent of the point where the first touch in put was made, for example, the centre of the object 43.

FIG. 3C illustrates an example of a second touch input being made and the corresponding geometric transformation. The second touch input is a trace input which starts at a first point 71 in the corner of the object 43 diagonally opposite to the invariant point 63 and extends in the direction of the diagonal of the object 43, as indicated by the arrow 75, to a second point 73. As the trace input is collinear with the invariant point 63 the processor 3 will recognize that the geometric transformation to be performed is just a resealing of the object 43. The processor 3 will also determine that as the end point 73 of the trace is closer to the invariant point 63 than the start point 71 the resealing will be a decrease in the size of the object presented 43.

In the embodiment illustrated in FIG. 3C the amount of the rescaling of the object 43 is directly proportional to the length of the trace of the second touch input so that the point of the object which was originally displayed at the start point 71 of the trace is displayed at the end point 77 once the geometric transformation is completed.

It is to be appreciated that if the user were to make a trace extending in the opposite direction to the arrow 75 so that the end point 73 of the trace was further from the invariant point 63 than the start point 71 then the resealing would be an increase in the size of the object 43.

FIG. 3D illustrates a second example of a second touch input in a sequence of touch inputs and the corresponding geometric transformation. In this second example the second touch input is also a trace input which starts at a first point 71 in the corner of the object 43 diagonally opposite to the invariant point 63. However in this example the trace is made in a vertical direction, parallel to the short side 47 of the object 43 as indicated by the arrow 75 and ends at the second point 73. In this example the trace is not collinear with the invariant point 63 so the processor will recognize that the geometric transformation defined by the trace is a rotation about the invariant point 63. The angle of the rotation is determined by the angle between the line connecting the invariant point 63 and the end point 73 of the trace and the line connecting the invariant point 63 and the start point 71 of the trace.

Also in the example illustrated in FIG. 3D the end point 73 of the trace is closer to the invariant point 63 than the start point 71 of the trace so the object 43 is also rescaled by an amount proportional to the reduction in distance between the points 71, 73 of the trace and the invariant point 63 so that the geometric transformation performed in response to the trace input of FIG. 3D is a combination of both a rotation and a rescaling.

Therefore it can be appreciated that the displacement of the trace defines the geometric transformation performed and, in this embodiment, is resolved into two separate components, a radial component which determines the amount by which the object 43 is rescaled and an azimuthal component which determines the amount by which the object 43 is rotated.

FIG. 3E illustrates an example of a graphical user interface 41 in which the user moves the invariant point 63. In this example the user has made a trace which starts at the invariant point 63 in the top left hand corner 51 of the object 43 and extends to a different point 81 within the object 43. In response to this input the processor 3 will move the invariant point 63 so that the second point 81 within the object 43 becomes defined as the invariant point 63. The second point 81 then becomes the fixed point for any subsequent geometric transformations.

The blocks illustrated in the FIG. 2 may represent steps in a method and/or sections of code in the computer program 7. The illustration of a particular order to the blocks does not necessarily imply that there is a required or preferred order for the blocks and the order and arrangement of the blocks may be varied.

Although embodiments of the present invention have been described in the preceding paragraphs with reference to various examples, it should be appreciated that modifications to the examples given can be made without departing from the scope of the invention as claimed. For example in the described embodiment the rescaling of an object rescales both the horizontal and perpendicular dimensions so that, for a rectangular object, both the length and the width will be rescaled by the same proportion. In other embodiments it may be possible to rescale the dimensions independently of each other so that the length and width could be rescaled by different proportions.

It should also be appreciated that means other than the touch sensitive input device may be used to make inputs in the sequence of inputs. For example a user may cancel the invariant point by actuating a key on a keypad, or may define the invariant point by actuating a particular key.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a display configured to present an object;
a touch sensitive input device configured to enable a user to make touch inputs, including trace inputs; and
a processor configured to perform a geometric transformation of the object on the display in response to a sequence of distinct touch inputs of the touch sensitive input device, the sequence including a first touch input and a second touch input wherein the first touch input in the sequence defines an invariant point in the object and the second touch input in the sequence defines the geometric transformation.

2. An apparatus as claimed in claim 1 wherein the invariant point is defined as the point of the object at which the first touch input was made.

3. An apparatus as claimed in claim 2 wherein the processor is configured to control the display to present an indication of the invariant point once the invariant point has been defined.

4. An apparatus as claimed in claim 1 wherein the touch sensitive input device is configured to enable a user to make touch inputs via the display.

5. An apparatus as claimed in claim 4 wherein the first touch input is made via any region of the display in which the first object is presented.

6. An apparatus as claimed in claim 1 wherein the first input is a predetermined type of input.

7. An apparatus as claimed in claim 1 wherein the first touch input is the actuation of an area of the touch sensitive user input device for at least a predetermined time period.

8. An apparatus as claimed in claim 1 wherein the second touch input is a trace input.

9. An apparatus as claimed in claim 8 wherein the processor is configured to measure the trace of the second touch input with respect to the invariant point.

10. An apparatus as claimed in claim 8 wherein the trace of the second touch input starts anywhere within the region of the display in which the first object is presented.

11. An apparatus as claimed in claim 8 wherein the length and direction of the trace of the second touch input determines the geometric transformation.

12. An apparatus as claimed in claim 1 wherein the geometric transformation is a resealing of the object.

13. An apparatus as claimed in claim 1 wherein the geometric transformation is a rotation of the object about the invariant point.

14. A method comprising:
presenting an object on a display;
detecting a sequence of distinct touch inputs on a touch sensitive user input device, the sequence including a first touch input and a second touch input;
defining, in response to the detection of the first touch input, an invariant point of the object; and
performing, in response to the detection of the second touch input, geometric transformation of the object about the invariant point wherein the second touch input defines the geometric transformation.

15. A method as claimed in claim 14 wherein the invariant point is defined as the point of the object at which the first touch input was made.

16. A method as claimed in claim 14 further comprising presenting an indication of the invariant point.

17. A method as claimed in claim 14 wherein the touch inputs are made via the display.

18. A method as claimed in claim 14 wherein the first touch input is made via any region of the display in which the first object is presented.

19. A method as claimed in claim 14 wherein the first input is a predetermined type of input.

20. A method as claimed in claim 14 wherein the first touch input is the actuation of an area of the touch sensitive user input device for at least a predetermined time period.

21. A method as claimed in claim 14 wherein the second touch input is a trace input.

22. A method as claimed in claim 21 wherein the trace of the second touch input is measured with respect to the invariant point.

23. A method as claimed in claim 21 wherein the trace of the second touch input starts anywhere within the region of the display in which the first object is presented.

24. A method as claimed in claim 21 wherein the length and direction of the trace of the second touch input determines the geometric transformation.

25. A method as claimed in claim 14 wherein the geometric transformation comprises a change in size of the presentation of the object.

26. A method as claimed in claim 14 wherein the geometric transformation comprises a rotation of the object about the invariant point.

27. A computer program comprising program instructions for controlling an apparatus, the apparatus comprising, a display configured to present an object and a touch sensitive input device configured to enable a user to make touch inputs, including trace inputs, the program instructions providing, when loaded into a processor:
means for detecting a sequence of distinct touch inputs on a touch sensitive user input device, the sequence including a first touch input and a second touch input;
means for defining, in response to the detection of the first touch input an invariant point of the object; and
means for performing, in response to the detection of the second touch input, geometric transformation of the object about the invariant point wherein the second touch input defines the geometric transformation.

28. A physical entity embodying the computer program as claimed in claim 27.

29. An electromagnetic carrier signal carrying the computer program as claimed in claim 27.

30. A computer program comprising program instructions for causing a computer to perform the method of claim 14.

31. A user interface comprising:
a display for presenting an object in a first geometric configuration;
a touch sensitive input device configured to enable a user to make touch inputs, including trace inputs;
wherein the user interface is configured such that a geometric transformation of the object on the display is performed in response to a sequence of distinct touch inputs wherein a first touch input in the sequence defines an invariant point in the object and a second touch input in the sequence determines the geometric transformation about the invariant point.

32. A user interface as claimed in claim 31 wherein the first touch input is the actuation of an area of the touch sensitive user input device for at least a predetermined time period.

33. A user interface as claimed in claim 31 wherein the second touch input is a trace input.

34. An apparatus comprising:
a display configured to present an object;
a touch sensitive input device configured to enable a user to make touch inputs, including trace inputs; and
a processor configured to perform a function on the object on the display in response to a sequence of distinct touch inputs of the touch sensitive input device, the sequence including a first touch input and a second touch input wherein the first touch input in the sequence defines an invariant point in the object and the second touch input in the sequence defines the function.

35. An apparatus as claimed in claim 34 wherein the invariant point is defined as the point of the object at which the first touch input was made.

36. A processor configured to control a display to present an object and detect inputs, including trace inputs, on a touch sensitive device wherein the processor is configured to perform a geometric transformation of the object on the display in response to the detection of a sequence of distinct touch inputs of the touch sensitive input device, the sequence including a first touch input and a second touch input wherein the first touch input in the sequence defines an invariant point in the object and the second touch input in the sequence defines the geometric transformation.

37. A processor as claimed in claim 36 wherein the invariant point is defined as the point of the object at which the first touch input was made.
